(19) United States
(12) Patent Application Publication
(10) Pub. No.: US 2007/0168952 A1
(43) Pub. Date: Jul. 19, 2007

(54) Methods for producing, transferring, and renewing virtual machine applications using flash, and system thereof

(75) Inventors: Chong Min Lee, Gimpo-city (KR); Nam Ju Hwang, Seoul (KR); Myung Ho Choi, Seoul (KR)

Correspondence Address: Richard P. Berg;Ladas & Parry, Suite 2100, 5670 Wilshire Boulevard, Los Angeles, CA, 90036, US

(73) Assignee: Geotel Corporation

(21) Appl. No.: 11/291,341

(22) Filed: Nov. 30, 2005

(51) Int. Cl. G06F 9/44; G06F 9/45

(52) U.S. Cl. 717/118; 717/148

(57) ABSTRACT

The present invention relates to a VM (Virtual Machine) application program that can be used in a wireless terminal having a VM. A generated flash file is converted to a flash file for a wireless terminal, and a VM application program is produced by incorporating the wireless terminal flash file into a VM frame including a flash engine for running the wireless terminal flash file and a flash-VM interface for exchanging data with a VM provided in the wireless terminal. By a method for producing the VM application program, a VM application program can be easily developed by generating the flash file and converting the same, a VM application program including the flash file can be executed in a wireless terminal having a VM therein, and a VM application program can be renewed by only downloading a flash file.

### BACKGROUND OF THE INVENTION

(a) Field of the Invention

The present invention relates to an application program executed in a virtual machine installed in a wireless terminal. More particularly, the present invention relates to a method for producing, transferring, and renewing a flash base application program executable by a virtual machine installed in a wireless terminal, and a system thereof.

(b) Description of the Related Art

Generally, a virtual machine (hereinafter, referred to as VM) is an operating platform solution that can download contents or an application program from a server via a wireless Internet and execute the same in a wireless terminal, and it allows use of multimedia services such as a game or moving image by executing the downloaded application program on the terminal in which the virtual machine is installed.

Recently, various services for downloading an application program executable by the VM installed in a wireless terminal (hereinafter, referred to as a VM application program) have been provided by wireless Internet service providers.

For such service, a wireless terminal having a VM, a VM application program download system capable of downloading a VM application program, and a VM application program service system for providing a service in using the downloaded VM application program are needed.

Therefore, if a user is connected to a download server using a download server-connecting program provided in a wireless terminal, the VM application program download system provides a list of application programs that can be installed in a VM. The user selects the VM application program from the list of the provided application programs, downloads the selected application program, and installs the same. Then, the user connects to the VM application program service system and uses the VM application program.

However, in order to produce a new VM program, we have to write the whole of the VM program for download. Therefore, substantial cost and time are needed to produce a new VM program, and it is difficult to respond to new needs in a wireless Internet service in a timely fashion. In particular, even when renewing the VM application program, we have to rewrite the whole of the application program using developing tools provided by the VM.

By the way, technologies for converting vector image data to data executable by a wireless terminal and an application program for executing the converted vector image data in a wireless terminal have been introduced.

As an example, a mobile flash file format operating in a similar way as a macromedia flash and a mobile flash player capable of executing the same in a wireless terminal are being used. A user can download a flash file converted for use in a wireless terminal, and manage the same as a data file.

That is, after executing a mobile flash player in a wireless terminal, a user connects to a flash download system providing mobile flash contents, downloads the flash file, and can store, run, or delete the same.

However, the mobile flash file cannot be played directly by the VM, and in order to run the mobile flash file, a separate player is needed. After executing such a separate player, a stored file can be selected or played. In addition, there is a problem in that in order to download a file, the player must be executed, and then a user must connect to a download server and search a file list.

Therefore, there is a problem in that the mobile flash file can only act as a simple content, but it cannot utilize whole functions such as a file system and a network function provided by the VM.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to increase usability for virtual machine application programs by providing easy methods for producing, transferring, and renewing virtual machine application programs.

An exemplary method for producing a VM application program that can be used in a wireless terminal provided with a VM includes generating at least one wireless terminal flash file, and producing a VM application program by incorporating the generated wireless terminal flash file into a VM frame.

The flash file is an image file of a vector graphic base, and a wireless terminal flash file is an image file of a vector graphic base that is produced to be executable in a wireless terminal.

The generating of the wireless terminal flash file may include generating a flash file and converting the generated flash file to be able to be executed in a wireless terminal. In another embodiment, the generating of the wireless terminal flash file may use a flash file-generating tool for a wireless terminal. In still another embodiment, the generating of the wireless terminal flash file may be done by importing a pre-produced wireless terminal flash file.

The VM frame may include a flash engine for running the wireless terminal flash file, and a flash-VM interface for exchanging data with a VM provided in the wireless terminal.

The flash-VM interface may include an event manager for transferring generated event information between the VM provided in the wireless terminal and the VM application program, a file manager for allowing the VM application program to be able to use a file system function provided by the VM, and a network manager for allowing the VM application program to be able to use a network function provided by the VM.

In an embodiment of the present invention, a method for transferring a VM application program that is executable in a wireless terminal provided with a VM through a wireless Internet includes, storing a VM application program produced by incorporating at least one wireless terminal flash file into a VM frame, receiving a transmission request signal for the VM application program from the wireless terminal, and transmitting the requested VM application program through the wireless Internet.

In another embodiment of the present invention, a method for renewing a VM application program produced by incorporating at least one wireless terminal flash file and a VM frame and downloaded to a wireless terminal includes, transmitting stored renewing information of the VM application program to the wireless terminal, receiving a renewing request signal from the wireless terminal, and transmitting a renewed wireless terminal flash file.

In an embodiment of the present invention, a computer-recording medium stores a program consisting of a plurality of instructions and performs predetermined steps for producing a VM application program that can be used in a wireless terminal provided with a VM. The predetermined steps include, generating a wireless terminal flash file, and producing a VM application program by incorporating the generated wireless terminal flash file into a VM frame.

In an embodiment of the present invention, a system for downloading a VM application program that is executable in a wireless terminal provided with a VM through a wireless Internet includes a VM application program database server storing and managing at least one VM application program, and a VM application program download server having a network interface for transmitting/receiving data to/from the wireless terminal and processing data transmitted/received data to/from the wireless terminal. The VM application program includes at least one wireless terminal flash file, and a VM frame for running a wireless terminal flash file and exchanging data between a VM provided in the wireless terminal.

In another embodiment of the present invention, a service system for a VM application program generated by incorporating at least one wireless terminal flash file into a VM frame and downloaded to a wireless terminal includes a service information database server storing and managing service information requested by a wireless terminal in using a VM application program, a flash file database server storing and managing at least one renewed wireless terminal flash file, and a VM application program service server having a network interface for transmitting/receiving data to/from the wireless terminal and processing data that is transmitted/received to/from the wireless terminal.

In an embodiment of the present invention, a wireless terminal provided with a VM and a real-time operating system includes a memory for storing at least one VM application program executed by the VM. The VM application program includes at least one wireless terminal flash file, and a VM frame for running a wireless terminal flash file and exchanging data between a VM provided in the wireless terminal.

### BRIEF DESCRIPTION OF THE DRAWINGS

FIG. 1 is a schematic diagram of a virtual machine application program according to an exemplary embodiment of the present invention.

FIG. 2 is a flowchart of a method of producing a virtual machine application program according to an exemplary embodiment of the present invention.

FIG. 3 is a diagram showing a virtual machine application program download system of a virtual machine application program transferring system, a virtual machine application program service system, and a wireless terminal.

FIG. 4 is a flowchart of a method of downloading a virtual machine application program using the virtual machine application program transferring system.

FIG. 5A to FIG. 5D show display images using a virtual machine application program.

FIG. 6 is a flowchart of a method of renewing a virtual machine application program using the virtual machine application program transferring system.

### DETAILED DESCRIPTION OF THE EMBODIMENTS

Exemplary embodiments of the present invention will hereinafter be described in detail with reference to the accompanying drawings.

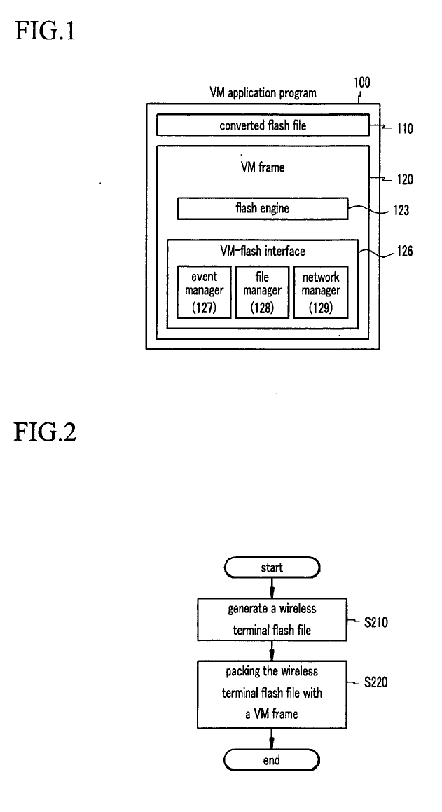

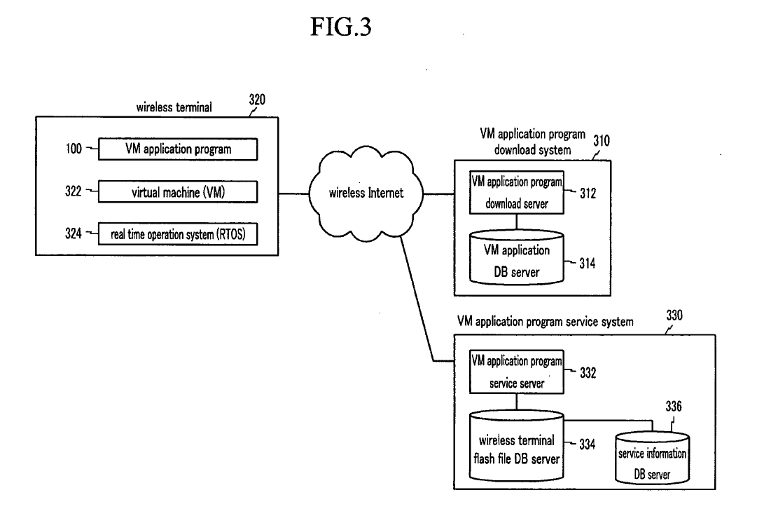

FIG. 1 is a schematic diagram of a virtual machine application program according to an exemplary embodiment of the present invention, and FIG. 2 is a flowchart of a method of producing a virtual machine application program according to an exemplary embodiment of the present invention.

A VM application program is an application program that is executable in a wireless terminal having a VM (virtual machine).

As shown in FIG. 1, a VM application program 100 includes a wireless terminal flash file 110, which is a flash file for use in a wireless terminal, and a VM frame 120 for running the wireless terminal flash file and providing an interface for exchanging data with the VM provided in the wireless terminal. The wireless terminal flash file may be a macromedia flash file itself or somewhat transformed file.

As shown in FIG. 2, in order to produce the VM application program, at least one wireless terminal flash file is generated at step S210, and the at least one wireless terminal flash file is incorporated into the VM frame to thereby package the VM application program at step S220.

The step S210 of generating the wireless terminal flash file may generate a flash file and then convert it to be executable in the wireless terminal may be performed using a flash file-generating tool for a wireless terminal, or may be performed by importing a pre-produced wireless terminal flash file.

In the case of generating the wireless terminal flash file by converting a flash file, a mobile flash file can be generated by converting a flash file produced by a macromedia flash. The mobile flash file may be a file having a wireless terminal flash file format provided by the Digital Aria company.

On the other hand, in the case of using the wireless terminal flash file-generating tool, the wireless terminal flash file can be generating using a VIS (Vector Image Solution) tool.

The VIS tool is a tool for generating a wireless terminal flash file and may be a wireless terminal flash file-generating tool provided by the NEO MTEL company.

In addition, in the case of importing the wireless terminal flash file, a wireless terminal flash file that has already been produced by a plurality of methods is used, and a mobile flash file or a wireless terminal flash file generated by a VIS tool may be imported and used.

The wireless terminal flash file generated at step S210 may be generated on the basis of a predetermined type of wireless terminal in which the VM application program is executed, and the predetermined type of wireless terminal may include at least one of a color type, a font type, a sound type, a resolution type, and a RAM type.

As shown in FIG. 1, the VM frame 120 is an application program by itself, and includes a flash engine 123 for running the wireless terminal flash file 110 and a flash-VM interface 126.

The flash engine 123 may be decoding software for playing over the wireless terminal flash file, and may be a mobile flash engine of the Digital Aria company or a Neo-VIS (Neo Vector Image Solution) engine of the NEO MTEL company.

The flash-VM interface 123 may include an event manager 127, a file manager 128, and a network manager 129.

The event manager 127 transfers generated event information (for example, key event information or wireless terminal system information such as an alarm or SMS (short message service)) between the VM provided in the wireless terminal and the VM application program, the file manager 128 allows the VM application program to be able to use a file system function provided by the VM, and the network manager 129 allows the VM application program to be able to use a network function provided by the VM.

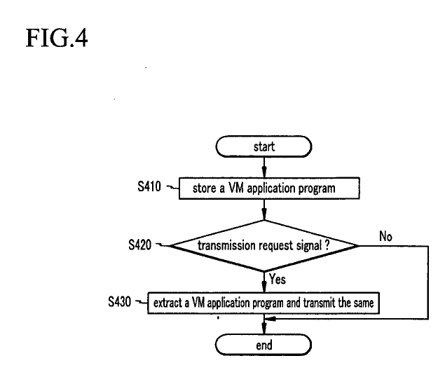

FIG. 3 is a diagram showing a virtual machine application program download system of a virtual machine application program transferring system, a virtual machine application program service system, and a wireless terminal.

As shown in FIG. 3, a VM application program download system 310 includes a VM application program download server 312, and a VM application program database server 314 storing and managing at least one VM application program. The system 310 is connected to a wireless terminal 320 via a wireless Internet and downloads the VM application program to the wireless terminal 320 in response to a request of the wireless terminal 320.

In addition, a VM application program service system 330 includes a VM application program service server 332, a flash file database server 334, and a service information database server 336.

The VM application program service server 332, if the VM application program 100 downloaded and stored in the wireless terminal 320 is executed, processes data in response to a request of the wireless terminal 320 and transmits the same to the wireless terminal 320. The flash file database server 334 stores at least one renewed wireless terminal flash file, and the service information database server 336 stores service information requested in executing the VM application program 100 stored in the wireless terminal 320.

By transmitting a data file needed for a service and the wireless terminal flash file in response to a request of the wireless terminal 320, using and renewing of each VM application program can be realized.

The wireless terminal 320 is connected to the VM application program download system 310 and the VM application program service system 330 via wireless Internet, and the wireless terminal 320 may be a mobile communication phone, a PDA, or a smart phone.

An RTOS (Real Time Operation System) and a VM (Virtual Machine) are installed in the wireless terminal 320.

The wireless terminal 320 may include a memory, and the VM application program downloaded from the VM application program download system 310, the service information downloaded from the VM application program service system 330, and the wireless terminal flash file for renewing are stored in the memory.

The wireless Internet may be realized by TCP/IP (Transmission Control Protocol/Internet Protocol) and HTTP (Hypertext Transfer Protocol), and it may be connected to any Internet protocol based on TCP/IP provided by the VM. This is obvious to a person of ordinary skill in the art, so a further detailed description thereof will be omitted.

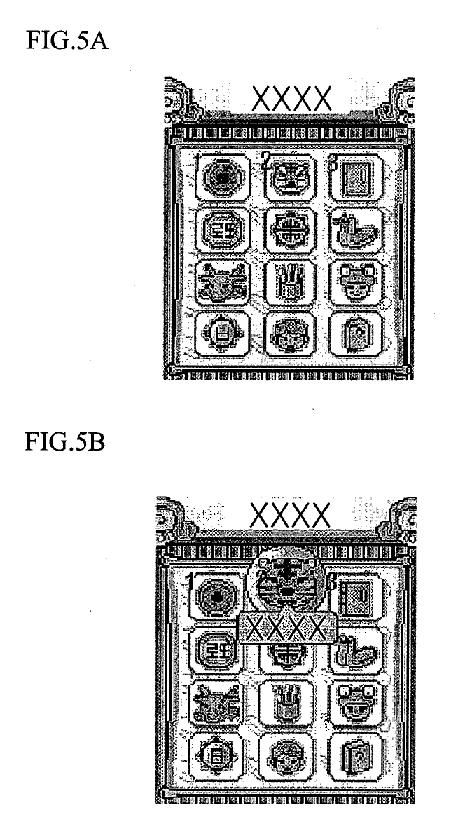

Referring to FIG. 4, a method for downloading a VM application program will be explained in detail.

The produced VM application program is stored in the VM application program database server 314 at step S410, and the VM application program download server 312 determines at step S420 whether there is a signal (i.e., a transmission request signal) for requesting transmission of a VM application program from the wireless terminal 320. If the determination is affirmative at step S420, the VM application program download server 312 extracts a requested VM application program from the VM application program database server 314 and transmits the extracted VM application program, at step S430.

The transmission request signal generated by the wireless terminal 320 may include information on a kind of a VM application program and type of the wireless terminal, and the VM application program download server 312 transmits a VM application program produced to be suitable to the type of the wireless terminal.

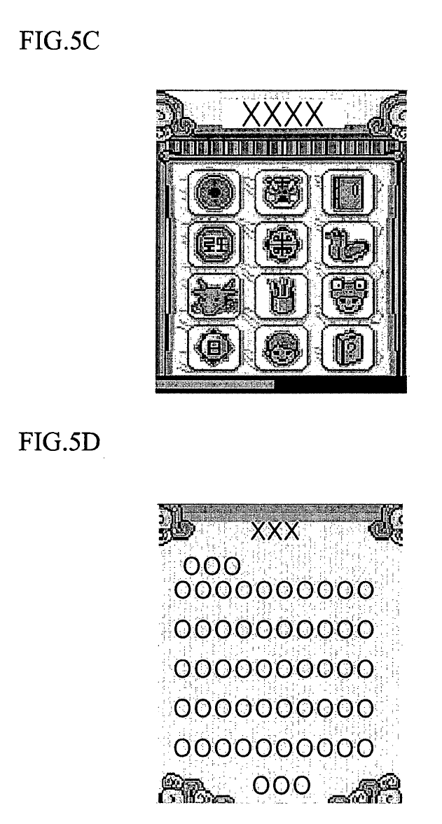

FIG. 5A to FIG. 5D show examples of display images when the VM application program stored in a memory of the wireless terminal 320 is executed.

FIG. 5A to FIG. 5D show display images using a virtual machine application program.

In more detail, the VM application program may include at least one wireless terminal flash file that may be executed by a flash engine for a wireless terminal included in a VM frame.

Each wireless terminal flash file is a client program, so it communicates with a VM application program service server using a VM frame and displays resulting data.

That is, when starting the program, an initial display image including various menus that can be selected by a user is displayed, and a user can generate key events by manipulating keys of the wireless terminal. The key events generated by a user are processed by the event manager of the VM-flash interface.

For example, if a user pushes a key of ‘2’ in a displayed image shown in FIG. 5A, the file manager of the VM-flash interface reads user's personal information that is input or stored, and connects to a network. Then, the network manager requests the corresponding information to the VM application program service server (FIG. 5A to FIG. 5C). At this time, the corresponding information may be any information intended to be obtained by pushing a key in a displayed image.

The VM application program service server extracts data processing results of the corresponding information from the service information database server and transmits the extracted results to the wireless terminal. The transmitted results, i.e., data on the corresponding information, is read by the wireless terminal flash file and is displayed on a display screen of the wireless terminal, as shown in FIG. 5D.

That is, the data processing results for the corresponding information are downloaded to the wireless terminal via the network manager, and are stored and managed by the file manager. The data processing results are displayed on a display screen of the wireless terminal by the wireless terminal flash file executed by a flash engine included in the VM application program.

The data for the corresponding information stored in the service information database server can be renewed by a service provider, and a VM application program user may receive the renewed data by executing the VM application program.

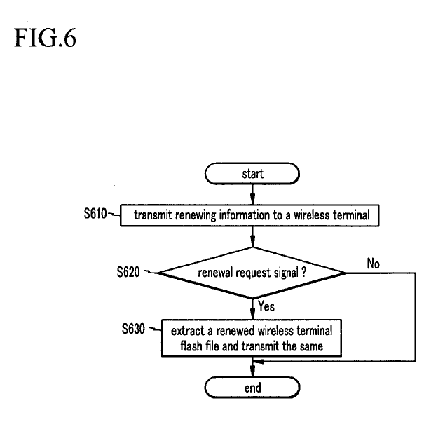

FIG. 6 is a flowchart of a method of renewing a virtual machine application program using the virtual machine application program transferring system.

If the wireless terminal flash file included in the VM application program is renewed, the renewed wireless terminal flash file is stored in the flash file database server, and renewing of the VM application program is performed by renewing the wireless terminal flash file stored in the wireless terminal.

In more detail, the VM application program service server transmits renewing information to the wireless terminal at step S610 and determines whether there is a request signal (i.e., a renewal request signal) for renewing the VM application program from the wireless terminal at step S620.

If the renewal request signal has been received, the VM application program service server extracts a renewed wireless terminal flash file of a corresponding VM application program from the flash file database server and transmits the same to the wireless terminal via wireless Internet, at step S630.

The transmitted wireless terminal flash file may substitute a prior wireless terminal flash file of a VM application program stored in the wireless terminal or it may be added to the VM application program.

That is, renewing the wireless terminal flash file performs the renewing of the VM application program.

Therefore, it is not necessary for a user to connect to the VM application program download system and download the whole of the renewed VM application program. By receiving a flash file included in the VM application program from the VM application program service system and substituting the previous wireless terminal flash file with the received flash file or adding the received flash file, the VM application program can be easily renewed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

In a method for producing a VM application program according to an embodiment of the present invention, only a flash file is generated and converted, so a VM application program can be easily developed, and in addition, since the flash file has already been converted to a VM application program, it can be directly executed by a VM.

In addition, in renewing the application program, an application program producer does not need to produce the whole of an application program but can renew the whole of the application program by only producing the wireless terminal flash file. In addition, a user can renew a VM application program stored in a wireless terminal by only receiving a renewed wireless terminal flash file.

Furthermore, since a size of an application program provided by an application program download server is substantially decreased and a flash file can be received from an application program service server and can be added in using an application program, the load of a download server can be decreased when an application program download server and an application program service server are separately managed.

That is, since a flash file is downloaded via wireless Internet and is substituted without changing a VM frame acting as a VM application program, an upgrade can be easily performed, and developing and verifying of an application program are not needed.

In addition, since flash programs can be selected from a list of application programs while being connected to an application program download server, it is one-step easier for the users to find flash programs than a conventional method where users execute flash player first to find the flash programs list as provided by the user-interface of the flash player.

In addition, a flash program for a wireless terminal can easily use the above-stated functions since a VM frame provides API for using a file system and a network. When a certain telecom operator company requires the flash applications to use directly somewhat customized TCP/IP connection, these flash VM applications can be easily adapted.

Furthermore, since an effect of flash animation can be realized in a VM application program, a dynamic GUI can be realized.

What is claimed is:

1. A method for producing a VM application program that can be used in a wireless terminal provided with a VM, comprising:
generating at least one wireless terminal flash file; and
producing a VM application program by incorporating the generated wireless terminal flash file into a VM frame.

2. The method of claim 1, wherein the generating of the wireless terminal flash file comprises:
generating a flash file; and
converting the generated flash file to be able to be executed in a wireless terminal.

3. The method of claim 2, wherein the converting is performed on the basis of a predetermined type of wireless terminal in which the VM application program is executed.

4. The method of claim 3, wherein the predetermined type of wireless terminal comprises at least one of a color type, a font type, a sound type, a resolution type, and a RAM type.

5. The method of claim 1, wherein the generating of the wireless terminal flash file uses a flash file-generating tool for a wireless terminal.

6. The method of claim 5, wherein the wireless terminal flash file generated by using the flash file-generating tool is generated on the basis of a predetermined type of wireless terminal in which the VM application program is executed.

7. The method of claim 6, wherein the predetermined type of wireless terminal comprises at least one of a color type, a font type, a sound type, a resolution type, and a RAM type.

8. The method of claim 1, wherein the generating of the wireless terminal flash file is done by importing a pre-produced wireless terminal flash file.

9. The method of claim 1, wherein
the VM frame comprises:
a flash engine for running the wireless terminal flash file; and
a flash-VM interface for exchanging data with a VM provided in the wireless terminal.

10. The method of claim 9, wherein the flash-VM interface comprises:
an event manager for transferring generated event information between the VM provided in the wireless terminal and the VM application program;
a file manager for allowing the VM application program to be able to use a file system function provided by the VM; and
a network manager for allowing the VM application program to be able to use a network function provided by the VM.

11. The method of claim 10, wherein the wireless terminal flash file is a macromedia flash file or somewhat transformed file.

12. The method of claim 10, wherein the wireless terminal flash file is a mobile flash file generated by converting a flash file produced by a macromedia flash.

13. The method of claim 10, wherein the wireless terminal flash file is a flash file produced by a VIS tool.

14. A method for transferring a VM application program that is executable in a wireless terminal provided with a VM through a wireless Internet, comprising:
storing a VM application program produced by incorporating at least one wireless terminal flash file into a VM frame;
receiving a transmission request signal for the VM application program from the wireless terminal; and
transmitting the requested VM application program through the wireless Internet.

15. The method of claim 14, wherein the VM frame comprises:
a flash engine for running a wireless terminal flash file; and
a flash-VM interface for exchanging data with a VM provided in the wireless terminal.

16. The method of claim 15, wherein the flash-VM interface comprises:
an event manager for transferring generated event information between the VM provided in the wireless terminal and the VM application program;
a file manager for allowing the VM application program to be able to use a file system function provided by the VM; and
a network manager for allowing the VM application program to be able to use a network function provided by the VM.

17. The method of claim 16, wherein the transmission request signal comprises type information of the wireless terminal.

18. A method for renewing a VM application program produced by incorporating at least one wireless terminal flash file and a VM frame downloaded to a wireless terminal, comprising:
transmitting stored renewing information of the VM application program to the wireless terminal;
receiving a renewing request signal from the wireless terminal; and
transmitting a renewed wireless terminal flash file.

19. The method of claim 18, wherein the renewing request signal comprises type information of the wireless terminal.

20. A computer recording medium for storing a program consisting of a plurality of instructions and performing predetermined steps for producing a VM application program that can be used in a wireless terminal provided with a VM,
wherein the predetermined steps comprise:
generating a wireless terminal flash file; and
producing a VM application program by incorporating the generated wireless terminal flash file into a VM frame.

21. The computer recording medium of claim 20, wherein the generating of the wireless terminal flash file comprises:
generating a flash file; and
converting the generated flash file to be able to be executed in a wireless terminal.

22. The computer recording medium of claim 21, wherein the flash file is a flash file produced by a macromedia flash and the wireless terminal flash file is a mobile flash file.

23. The computer recording medium of claim 22, wherein the converting is performed on the basis of a predetermined type of wireless terminal in which the VM application program is executed.

24. The computer recording medium of claim 23, wherein the predetermined type of wireless terminal comprises at least one of a color type, a font type, a sound type, a resolution type, and a RAM type.

25. The computer recording medium of claim 20, wherein the generating of the wireless terminal flash file uses a flash file-generating tool for a wireless terminal.

26. The computer recording medium of claim 25, wherein the flash file-generating tool for the wireless terminal is a VIS.

27. The computer recording medium of claim 26, wherein the wireless terminal flash file generated by using the flash file-generating tool is generated on the basis of a predetermined type of wireless terminal in which the VM application program is executed.

28. The computer recording medium of claim 27, wherein the predetermined type of wireless terminal comprises at least one of a color type, a font type, a sound type, a resolution type, and a RAM type.

29. The computer recording medium of claim 20, wherein the generating of the wireless terminal flash file is done by importing a pre-produced wireless terminal flash file.

30. The computer recording medium of claim 29, wherein the wireless terminal flash file is a mobile flash file generated by converting a flash file produced by a macromedia flash.

31. The computer recording medium of claim 29, wherein the wireless terminal flash file is a flash file produced by a VIS tool.

32. A system for downloading a VM application program that is executable in a wireless terminal provided with a VM through a wireless Internet, comprising:
a VM application program database server storing and managing at least one VM application program; and
a VM application program download server having a network interface for transmitting/receiving data to/from the wireless terminal and processing data that is transmitted/received to/from the wireless terminal;
wherein the VM application program comprises
at least one wireless terminal flash file, and
a VM frame for running a wireless terminal flash file and exchanging data between a VM provided in the wireless terminal.

33. The system of claim 32, wherein the VM frame comprises:
a flash engine for running the wireless terminal flash file; and
a flash-VM interface for exchanging data with a VM provided in the wireless terminal.

34. The system of claim 33, wherein the flash-VM interface comprises:
an event manager for transferring generated event information between the VM provided in the wireless terminal and the VM application program;
a file manager for allowing the VM application program to be able to use a file system function provided by the VM; and
a network manager for allowing the VM application program to be able to use a network function provided by the VM.

35. The system of claim 34, wherein the wireless terminal flash file is a mobile flash file generated by converting a flash file produced by a macromedia flash.

36. The system of claim 34, wherein the wireless terminal flash file is a flash file produced by a VIS tool.

37. A service system for a VM application program generated by incorporating at least one wireless terminal flash file into a VM frame and downloaded to a wireless terminal, comprising:
a service information database server storing and managing service information requested by a wireless terminal in using a VM application program;
a flash file database server storing and managing at least one renewed wireless terminal flash file; and
a VM application program service server having a network interface for transmitting/receiving data to/from the wireless terminal and processing data transmitted/received data to/from the wireless terminal.

38. The service system of claim 37, wherein the VM application program downloaded to the wireless terminal is renewed by a wireless terminal flash file from the flash file database.

39. A wireless terminal provided with a VM and a real-time operating system, comprising a memory storing at least one VM application program executed by the VM,
wherein the VM application program comprises:
at least one wireless terminal flash file; and
a VM frame for running a wireless terminal flash file and exchanging data between a VM provided in the wireless terminal.

40. The wireless terminal of claim 39, wherein the VM frame comprises:
a flash engine for running the wireless terminal flash file; and
a flash-VM interface for exchanging data with a VM provided in the wireless terminal.

41. The wireless terminal of claim 40, wherein the flash-VM interface comprises:
an event manager for transferring generated event information between the VM provided in the wireless terminal and the VM application program;
a file manager for allowing the VM application program to be able to use a file system function provided by the VM; and
a network manager for allowing the VM application program to be able to use a network function provided by the VM.

42. The wireless terminal of claim 41, wherein the wireless terminal flash file is a mobile flash file generated by converting a flash file produced by a macromedia flash.

43. The wireless terminal of claim 41, wherein the wireless terminal flash file is a flash file produced by a VIS tool.
